(19) United States
(12) Patent Application Publication
(10) Pub. No.: US 2018/0328570 A1
(43) Pub. Date: Nov. 15, 2018

(54) LASER PROJECTION LIGHT

(71) Applicant: Guangdong YUHAO Electronics Co., Ltd., Dongguan (CN)

(72) Inventor: Jun Xi, Dongguan (CN)

(21) Appl. No.: 15/698,689

(22) Filed: Sep. 8, 2017

(30) Foreign Application Priority Data
May 11, 2017 (CN) 201720521493.2
Aug. 18, 2017 (CN) 201721036927.6

(51) Int. Cl. F21V 14/04; G09G 3/00; F21V 11/02; F21V 23/00

(52) U.S. Cl. CPC F21V 14/04; G09G 3/003; F21Y 2113/13; F21V 23/006; F21V 11/02

(57) ABSTRACT

A laser projection light includes a housing defining a light outlet window; a grating assembly near the light outlet window, a first laser device, a second laser device, a optical lens used for reflecting a part of laser light from the first laser device along a first direction and permitting the other part of the laser light to pass through, a first optical reflector used for reflecting laser light which has passed through the first optical lens, a second optical reflector located in the first direction, a third optical reflector configured in the second direction, and one or two drive devices having two drive shafts connected with the second optical reflector and the third optical reflector respectively. The second and the third optical reflectors are driven by the one or two drive devices via the two drive shafts to rotate synchronously or unsynchronously.

### BACKGROUND OF THE INVENTION

### 1. Field of the Invention

The present invention relates to laser projection lights, and particularly to a laser projection light capable of projecting animated graphics moving up and/or down uninterruptedly in a motionless background pattern.

### 2. Description of Related Art

Traditional laser projection lights typically include an LED source and two spherical lenses, the LED source is driven to rotate from up towards down to projecting patterns of moving from up towards down. Because of the spherical lenses, the light will bend towards the center and a marginal zone of the projected patterns become deformed, that is, light spots in the marginal zone become bigger, scattered and border twisted. Furthermore, when the LED source moved to a lowest point, it may go out then light up after it moves back to a start point. Therefore the up-to-down movement of the projected patterns will be interruptedly. Therefore, there is a need to provide an improved laser projection light capable of projecting patterns moving up and/or down uninterruptedly in a motionless background pattern and the projected patterns have no deformation.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1 is an exploded view of a laser projection light in accordance with a first embodiment of the present invention.

FIG. 2 is an exploded view of a main part of the laser projection light in accordance with the first embodiment of the present invention.

FIG. 3 is an exploded view of a laser projection light in accordance with a second embodiment of the present invention, a housing is not shown.

FIG. 4 is a perspective view of the laser projection light in FIG. 3.

### DETAILED DESCRIPTION OF THE INVENTION

The invention will now be described in detail through several embodiments with reference to the accompanying drawings.

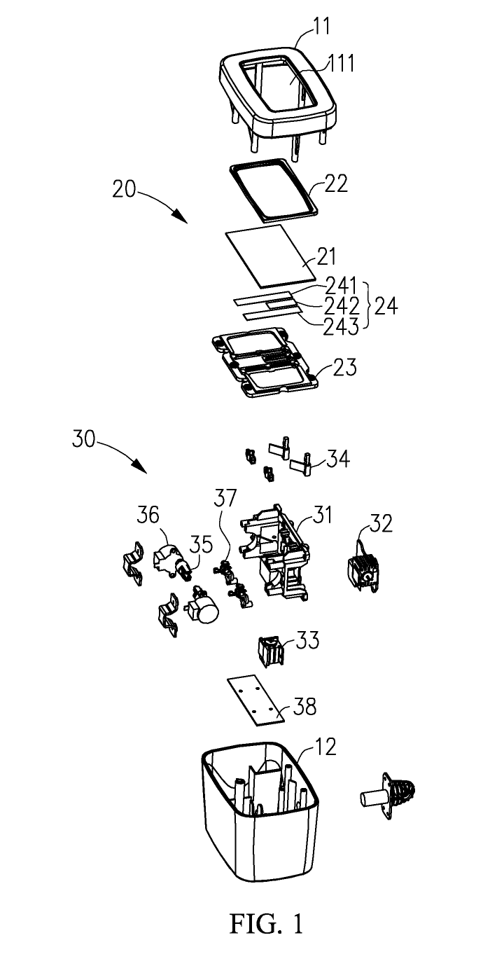

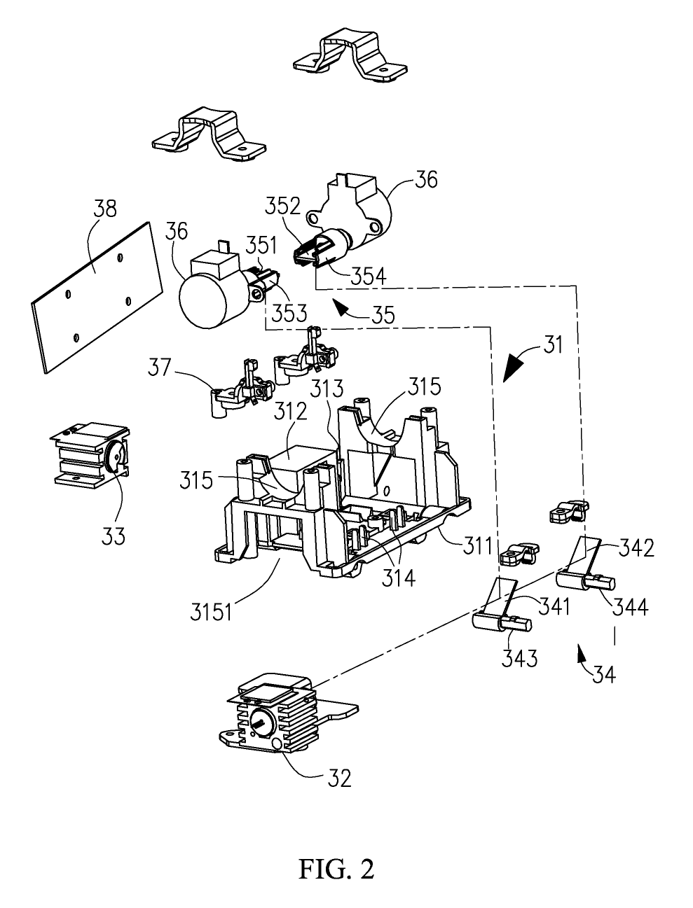

Please refer to FIG. 1 and FIG. 2, a laser projection light in accordance with a first embodiment of the present invention mainly includes a housing composed of a front cover 11 and a back cover 12, a front optical process assembly 20 and a central assembly 30.

The front cover 11 define a light outlet window (a through hole) 111. The front optical process assembly 20 mainly includes a transparent sheet 21 sealing the light outlet window 111 from an inner side of the housing, a sealing ring 22 located between the front cover 11 and the transparent sheet 21 for filling a gap between the front cover 11 and the transparent sheet 21, a grating support 23 fixed to a inner side wall of the front cover 11, and three gratings 24 (a first grating 241, a second grating 242 and a third grating 243) clamped between the grating support 23 and the transparent sheet 21. The transparent sheet 21 may be made from glass or any other transparent materials. The sealing ring 22 may be a silicone seal. The first grating 241, the second grating 242 and the third grating 243 stand side by side and are rectangular. The second grating 242 is located in the middle and has a smaller size when compared with the first and the third gratings 241, 243. The first grating 241 and the third grating 243 are located on two sides of the second grating 242. It is understandably, the three gratings 241 may be integrated in one-piece.

The central assembly 30 mainly includes a fixed mount 31, a first laser device 32, a second laser device 33, a first laser process assembly 34, a second laser process assembly 35, two drive devices 36, two microswitches 37 and a control board 38. The first laser device 32, the second laser device 33, the first laser process assembly 34, the second laser process assembly 35, the two drive devices 36, the two microswitches 37 and the control board 38 are all fixed on the fixed mount 31.

In the embodiment, the first laser device 32 and the second laser device 33 all include a substantially rectangular heat sink and a laser head mounted in a hole defined by the heat sink. The colors of the laser light emitted from the laser heads of the first and second laser devices 32, 33 are different. In other embodiment, two or more laser heads with different color may be mounted in each heat sink. In the embodiment, the second laser device 33 is mainly used for projecting a still background pattern, and the first laser device 32 is mainly used for projecting a moving major pattern in a region defined by the still background pattern. For example, the first laser device 32 utilizes a green laser head, and the second laser device 33 utilizes a blue laser head. The laser lights from the first and the second laser devices 32, 33 pass through different gratings, an animation of a lot of green snow flakes falling in a blue starry sky may be projected.

The first laser process assembly 34 includes an optical lens 341 and a first optical reflector 342 each of which including a post 343, 344 extending from the optical lens 341 and the first optical reflector 342 respectively. The optical lens 341 permits a part of laser light projected on it to transmit it and permits the other part of the laser light to reflect from it, a beam splitting mirror, for example. The first optical reflector 342 is a completely reflecting mirror.

The second laser process assembly 35 includes a second optical reflector 351 and a third optical reflector 352 both of which are received in U-shaped holders 353, 354 respectively. Two fixing posts extend from ends of the U-shaped holders 353, 354 respectively and are connected with the drive shafts of the two drive devices 36 respectively. As such, the second optical reflector 351 and the third optical reflector 352 can rotate around axes defined by the drive shafts of the two drive devices 36 respectively. In the embodiment, the second optical reflector 351 and the third optical reflector 352 are completely reflecting mirrors.

The two drive devices 36 are used for driving the second optical reflector 351 and the third optical reflector 352 to rotate synchronously or unsynchronously around axes defined by the drive shafts of the two drive devices 36 respectively. In the embodiment, the two drive devices 36 are both of stepping motors. It is understandably, in other embodiment, the drive devices 36 may be motors of other types, or may include one or two cylinders and gear sets.

The two microswitches 37 are used for controlling rotate angles of the second optical reflector 351 and the third optical reflector 352. In detail, when the second optical reflector 351 rotates to a first predetermined angle, one (first microswitch) of the two microswitches 37 will be triggered and capable of outputting a signal. When the third optical reflector 352 rotates to a second predetermined angle, the other (second microswitch) of the two microswitches 37 will be triggered and capable of outputting a signal. In the embodiment, the two microswitches 37 are electrically connected with the control board 38 and are mechanical connected to the fixed mount 31.

The control board 38 includes a PCB on which a power circuit used for supplying power to other components on the control board 38 and a control circuit used for controlling the drive devices 36, and the first and the second laser devices 32, 33 are connected.

The fixed mount 31 mainly includes a base plate 311, a second laser device support 312, two drive device supports 315, and two switch supports 313. The base plate 311 is substantially perpendicular to the plane defined by edges defining the light outlet window 21. In the embodiment, the transparent sheet 21 is a flat plane, therefore, the base plate 311 is substantially perpendicular to the sheet 21 and is connected to the back cover 12. The second laser device support 312 extends perpendicularly from a side far away from the light outlet window 21 of the base plate 311 and is used for supporting the second laser device 33. The two drive device supports 315 is located at two sides of the second laser device support 312 and each supports a motor acting as the drive device 36. The two switch supports 313 are located near the two drive device supports 315 and close to the side far away from the light outlet window 21 of the base plate 311. A lower part of one of the two drive device supports 315 defines a hollow 3151, the first laser device 32 is fixed in the hollow 3151 with the laser head facing the other of the two drive device supports 315. A laser light emitted from the first laser device 32 is substantially parallel with the sheet 21 (that is, the plane defined by edges defining the light outlet window 21).

Further more, two post holders 314 extend perpendicularly from a side near the light outlet window 21 of the base plate 311 and is used for supporting the second laser device 33. The posts 343, 344 extending from the optical lens 341 and the first optical reflector 342 are fixed to the two post holders 314, respectively, such that the optical lens 341 and the first optical reflector 342 are located in a light path of the first laser device 32. The optical lens 341 and the first optical reflector 342 are tilted 45 degrees relative to the laser light from the first laser device 32, such that a part of the laser light projected to the optical lens 341 is reflected (along a first direction) to a higher position of the base plate 311 than the optical lens 341, and the other part of the laser light transmits through the optical lens 341 and is reflected (along a second direction) to a higher position of the base plate 311 than the optical lens 341 by the first optical reflector 342. In the embodiment, the first direction is the same as the second direction. In other embodiment, the first and the second directions may be different.

The two drive devices 36 are fixed to the two drive device supports 315, and the drive shafts of the two drive devices 36 face (point to) each other and are in the same line which is parallel with the sheet 21 (in other words, the plane defined by edges defining the light outlet window 111). The two fixing posts extending from the ends of the U-shaped holders 353, 354 of the second optical reflector 351 and the third optical reflector 352 are connected to the drive shafts of the two drive devices 36, respectively. Centers of the second optical reflector 351 and the third optical reflector 352 are lined in the line defined by the two drive shafts of the two drive devices 36 when the second optical reflector 351 and the third optical reflector 352 are rotating, and are located in the reflecting paths (the first direction and the second direction) of the optical lens 341 and the first optical reflector 342, respectively. Therefore, laser lights reflected by the optical lens 341 and the first optical reflector 342 are reflected by the second optical reflector 351 and the third optical reflector 352 again.

The two microswitches 37 are fixed to the two switch supports 313 located near the two drive device supports 315. When the second optical reflector 351 rotates to the first predetermined angle, the U-shaped holder 353 contacts one (first microswitch) of the two microswitches 37, and the corresponding microswitch 37 is triggered and outputs a signal to the control board 38. When the third optical reflector 352 rotates to the second predetermined angle, the U-shaped holder 354 contacts the other (second microswitch) of the two microswitches 37, and the corresponding microswitch 37 is triggered and outputs a signal to the control board 38. In responding to the microswitches 37, one or two preset control flows are executed, such as but not limited to a rotating direction of the drive shafts of the drive devices 36 is reversed, or the drive shafts of the drive devices 36 rotates to a original position, and/or a working model of the first and the second laser device is changed.

The second laser device 33 is fixed on the second laser device support 312, the laser head of the second laser device 33 points to a center of the sheet 21 and is located between the second optical reflector 351 and the third optical reflector 352. In other words, a light path of the second laser device 33 is perpendicular to the sheet 21.

In the embodiment, three color diffraction gratings 24 are utilized. The first grating 241 and the third grating 243 are used for receiving light from the second optical reflector 351 and the third optical reflector 352, respectively, and the second grating 242 are used for receiving light from the second laser device 33. In the embodiment, the second laser device and the second grating 242 are together used to project a still background pattern (a first predetermined pattern), such as but not limited to a starry sky, a blue sky with white cloud, a sky with aurora borealis, et al. The first laser device 32, the second optical reflector 351 and the drive device 36 are together used to project a first moving major pattern (a second predetermined pattern) in a region defined by the still background pattern. The first moving major pattern may be falling snowflakes, or falling flowers, or falling leaves, et al. The first laser device 32, the third optical reflector 352 and the drive device 36 are together used to project a second moving major pattern (a third predetermined pattern) in the region defined by the still background pattern. The first and the second moving major patterns may be the same or different. Preferably, diffraction apertures on the first and the third gratings 241, 243 are irregular and nonuniform distributed, as such, moving tracks of the falling snowflakes, or falling flowers, or falling leaves, et al. change fantasticality during falling, closer to reality.

Control board 38 is fixed to a position between the second laser device 33 and the back cover 12, it can be directly fixed to the second laser device 33 or can be fixed to a support which is connected to the fixed mount 31. In the other embodiment, the control board 38 may be fixed to an inner wall of the back cover 12. A surface, facing the bottom of the back cover 12, of the control board 38 includes several control buttons (not shown) protruding out of the back cover 12 through several holes defined in the bottom of the back cover 12. Users can control the laser projection light via the control buttons, such as turn on/off the light, change an operation mode, et al.

In operation, when the laser projection light is power on, the first and the second laser devices 32, 33 both give out laser light. The laser light from the second laser device 33 arrives the second grating 242 and is split into a still background pattern. The laser light from the first laser device 32 arrives the optical lens 341, a part of it is reflected to the second optical reflector 351 by the optical lens 341 and then reflected by the second optical reflector 351 towards the first grating 241, the other part of the laser light is transmitted by the optical lens 341, then reflected by the first optical reflector 342, and finally reflected by the third optical reflector 352 towards the third grating 243. At the same time, the drive devices 36 drive the second optical reflector 351 and the third optical reflector 352 to rotate synchronously or unsynchronously, respectively.

Preferably, when the laser light arriving the first grating 241 moves to a lowest position, the laser light arriving the third grating 243 moves back to a highest position, and moving speeds from the highest position to the lowest position of the laser lights are the same. Furthermore, Therefore, the projected animation is continuous going on without a break, an uninterrupted flow.

Because the sheet 21 is plane and not curved or spherical, therefore there is no deformation in the whole patterns.

In other embodiment, the moving speeds of the second optical reflector 351 and the third optical reflector 352 may be different, and the first and the second moving major patterns may also different, thus the projected patterns are varied and can change fantasticality.

Furthermore, the fixed mount 31 is preferably made from metal material with good thermal conductivity (such as aluminum alloy), and it may contact an external radiator a part of which inserts in the housing. Therefore, an inner heat can be dissipated quickly.

In other embodiment, the first laser process assembly may include one optical reflector and two or more optical lenses lined in a line. Each optical lens reflect a part of received laser light and transmit the other part of the received laser, and the one optical reflector located farthest from the first laser device is a completely reflecting mirror. Correspondingly, the second laser process assembly may include three or more optical reflectors used for reflecting laser light from the one optical reflector and two or more optical lenses. Correspondingly, the number of the drive device may be three or more. The number of the gratings may be four or more, and patterns of the diffraction apertures on the gratings may be different or the same. Richer projection patterns and animation effects can be achieved

In the embodiment, each grating receives only the laser light from one of the second laser device, the second optical reflector 351 and the third optical reflector 352. In other embodiment, the laser light from one of the second laser device, the second optical reflector 351 and the third optical reflector 352 may be received by two adjacent gratings.

In the embodiment, the sheet 21 is a plane transparent glass. In the other embodiment, the sheet 21 may have circular arc or curved surfaces.

In other embodiment, one or all the microswitches may be omitted. The second optical reflector 351 and the third optical reflector 352 may be controled according to preset time periods.

In other embodiment, an emitting direction (the light path) of the first laser device may be not parallel to the sheet 21 (that is, the plane defined by edges defining the light outlet window 21). The rotation axis of the second optical reflector 351 and the third optical reflector 352 may be in different line and not parallel to each other, as long as the laser light can be reflected to the corresponding gratings and can move from an upper side to a lower side of the gratings.

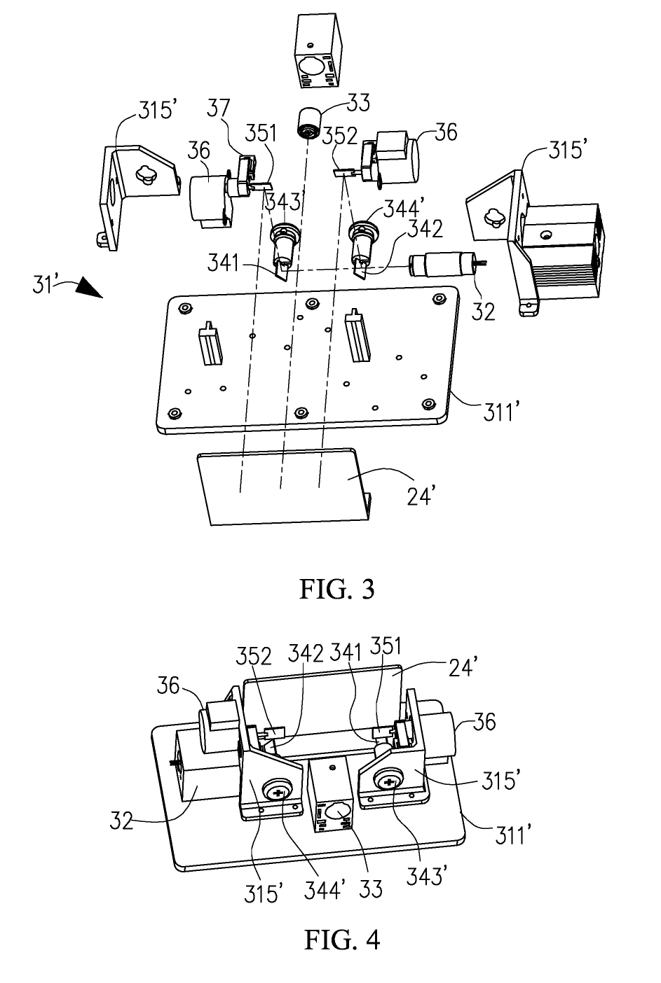

In other embodiment, a structure of the fixed mount may be different from the first embodiment. For example, in a second embodiment as shown in FIG. 3 and FIG. 4, the fixed mount 31′ mainly includes a base plate 311′ and two drive device supports 315′. The base plate 311′ is substantially perpendicular to the grating 24′ (in other words, a plane defined by edges defining a light outlet window of the housing (not shown)). The second laser device 33 is directly connected to the base plate 311′ and faces a center of the light outlet window of the housing. The two drive device supports 315′ is located at two sides of the second laser device 33 and each is substantially L-shaped.

Each drive device support 315′ includes a first support plate perpendicular to the base plate 311′ and the plane defined by edges defining the light outlet window of the housing, and a second support plate perpendicular to the base plate 311′ and parallel with the plane defined by edges defining the light outlet window of the housing. Each drive device 36 is fixed to the first support plate of a corresponding drive device support 315′ from a side away the other drive device 36. The first laser device 32 is fixed to the first support plate of one of the drive device supports 315′, and is located below the drive device 36. The first support plates define at least to through holes for permitting the drive shafts of the drive devices 36 and a front end of the laser head of the first laser device 32 to insert and locate between the two drive device supports 315′. The second optical reflector 351 and the third optical reflector 352 are connected to the drive shafts of the two drive devices 36, respectively.

The posts 343′, 344′ extending from the optical lens 341 and the first optical reflector 342 are fixed to the second support plates of the drive device supports 315′ from a side close to the grating 24′. The optical lens 341 and the first optical reflector 342 are located in a light path of the first laser device 32 and are preferably right below the second optical reflector 351 and the third optical reflector 352. In this embodiment, the grating 24′ is one-piece. Only one mcroswitches 37 is utilized and is located near the second optical reflector 351. The mcroswitches 37 is fixed to the second support plate of the drive device support 315′.

Operations and functions of the laser projection light in the embodiment is similar to those in the first embodiment.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A laser projection light, comprising:
a housing defining a light outlet window;
a grating assembly configured at an inner side of the light outlet window;
a first laser device comprising at least one laser head capable of emitting laser light with a first color;
a second laser device comprising at least one laser head capable of emitting laser light with a second color;
a optical lens configured for reflecting a part of laser light from the first laser device along a first direction and permitting the other part of the laser light from the first laser device to pass through;
a first optical reflector configured for reflecting laser light which has passed through the first optical lens along a second direction;
a second optical reflector configured in the first direction and configured for reflecting laser light from the optical lens;
a third optical reflector configured in the second direction and configured for reflecting laser light from the first optical reflector; and
one or two drive devices comprising two drive shafts connected with the second optical reflector and the third optical reflector respectively;
wherein the second and the third optical reflectors are driven by the one or two drive devices via the two drive shafts to rotate synchronously or unsynchronously.

2. The laser projection light according to claim 1, wherein the two drive shafts are substantially parallel with a plane defined by edges defining the light outlet window.

3. The laser projection light according to claim 1, wherein the grating assembly comprises a first grating, a second grating and a third grating configured side by side; the second grating is located in the middle and is configured for splitting laser light from the second laser device into a first predetermined pattern; the first grating is located on one side of the second grating and is configured for splitting laser light received from the second optical reflector into a second predetermined pattern; and the third grating is located on the other side of the second grating and is configured for splitting laser light received from the third optical reflector into a third predetermined pattern.

4. The laser projection light according to claim 3, wherein the first predetermined pattern comprises starry sky, the second and the third predetermined patterns are chosen from snowflakes, flowers, fallen leaves.

5. The laser projection light according to claim 4, patterns on the first and the third gratings are irregular distributed.

6. The laser projection light according to claim 1, further comprising a first microswitch configured near the second optical reflector, when the second optical reflector rotates to a first predetermined angle, the first microswitch is triggered and capable of outputting a signal.

7. The laser projection light according to claim 6, wherein further comprising a second microswitch configured near the third optical reflector, when the third optical reflector rotates to a second predetermined angle, the second microswitch is triggered and capable of outputting a signal.

8. The laser projection light according to claim 1, further comprising a fixed mount comprising:
a base plate substantially perpendicular to the plane defined by edges defining the light outlet window;
a second laser device support extending perpendicularly from a side far away from the light outlet window of the base plate and configured for supporting the second laser device; and
two drive device supports configured at two sides of the second laser device support and each supporting a motor acting as the drive device;
wherein the second and the third optical reflector are fixed to the drive shafts of the two motors respectively;
wherein a lower part of one of the two drive device supports defining a hollow, the first laser device is fixed in the hollow with the at least one laser head facing the other of the two drive device supports.

9. The laser projection light according to claim 8, wherein the optical lens and the first optical reflector are fixed in a light path of the first laser device and are fixed on a post holder extending perpendicularly from a side near the light outlet window of the base plate.

10. The laser projection light according to claim 9, wherein the optical lens and the first optical reflector are tilted 45 degrees relative to the laser light from the first laser device.

11. The laser projection light according to claim 10, further comprising a control board electrically connected with the two motors, the first laser device and the second laser device; wherein the control board is fixed between the second laser device support and the housing via a bracket, such that the control board has no direct contact with the second laser device.
